(19) United States
(12) Patent Application Publication
(10) Pub. No.: US 2015/0161932 A1
(43) Pub. Date: Jun. 11, 2015

(54) VIDEO DISPLAY DEVICE

(71) Applicant: SHARP KABUSHIKI KAISHA, Osaka-shi, Osaka (JP)

(72) Inventors: Hiroyoshi Kure, Osaka-shi (JP); Michiaki Takeda, Osaka-shi (JP)

(21) Appl. No.: 14/402,997

(22) PCT Filed: Mar. 19, 2013
(86) PCT No.: PCT/JP2013/057773

§ 371 Date: Nov. 21, 2014

(30) Foreign Application Priority Data
May 23, 2012 (JP) 2012-117364

(51) Int. Cl. G09G 3/20; G09G 3/36; G09G 3/34

(52) U.S. Cl. CPC G09G 3/2007; G09G 3/3406; G09G 3/36; G09G 2320/0271; G09G 2330/021; G09G 2320/0686

(57) ABSTRACT

In the present invention, when a main screen and one or more secondary screens are displayed, the screen luminance for the main screen can be suitably controlled without being affected by video signal for the secondary screens. A video display device (1) is provided with an LED backlight (7) that illuminates an LCD panel (5) and an area active control portion (3) that controls the light emission luminance of the LED backlight (7). The area active control portion (3) divides the LED backlight (7) into a plurality of areas and controls the light emission luminance of the LEDs corresponding to each area according to the video signal corresponding to each area. When the LCD panel (5) displays the main screen and one or more secondary screens, the control portion (3) controls the light emission luminance of the LEDs corresponding to the display area for the main screen in a range where a total value of drive current of the LED is equal to or less than a predetermined allowable current value based on a lighting rate of the LED backlight (7) for the main screen, and independently of this luminance control, controls the light emission luminance of an LED corresponding to a display area of the secondary screens to be constant.

### TECHNICAL FIELD

The present invention relates to a video display device, and more specifically relates to a video display device which divides a backlight into areas and controls luminance for each area.

### BACKGROUND OF THE INVENTION

In conventional video display devices provided with a liquid crystal panel and a backlight, a video is displayed by modulating a transmittance of the liquid crystal panel according to an input video and the liquid crystal panel is illuminated by the backlight. Some of these video display devices cause the backlight to always emit light with luminance of 100%, but there is a problem that power consumption becomes larger in this case.

Moreover, in recent years, a technology for controlling this light emission luminance of the backlight based on a feature amount of a video signal, for example, such as an APL (Average Picture Level) has been put into practical use. In the case of adopting this technology for display on a plurality of screens, however, there are some cases where incongruity is given to a viewer. For example, at a time of two-screen display, in a case where one video is dark and the other video is bright, light emission luminance control of a backlight light source is to be performed according to an intermediate feature amount therebetween, so that incongruity is given to the viewer.

Against this, for example, in Patent Document 1, a video display device which, in the case of displaying a plurality of screens, keeps light emission luminance control of a backlight light source with respect to a feature amount of an input video signal constant is disclosed.

As to the above-described video display device, one using an LED (Light Emitting Diode) backlight for illumination of a display panel is prevalent. In the case of the LED backlight, there is an advantage that local dimming is possible. The local dimming is a technology by which a backlight is divided into a plurality of areas to control light emission of an LED for each area according to a video signal of each area. For example, such control becomes possible that light emission of the LED is suppressed for a dark part in a screen and the LED is caused to emit light with high intensity for a bright part in the screen. This makes it possible to reduce power consumption of the backlight as well as to improve contrast of a display screen.

### PRIOR ART DOCUMENT

### Patent Document

Patent Document 1: Japanese Patent No. 4011104

### SUMMARY OF THE INVENTION

### Problem to be Solved by the Invention

As above, in conventional local dimming control which divides a backlight into a plurality of areas and controls luminance of an LED according to a video signal corresponding to each area, maximum luminance in each area is limited to luminance when all LEDs of the backlight are lit with a duty of 100%, and luminance control of the LEDs according to the video signal is performed within the limit. Thus, even when trying to improve contrast, for example, by making a bright video much brighter uniquely, there are limitations.

Against this, a method for performing PWM (Pulse Width Modulation) control so that power does not exceed a prescribed value and, when an area to be lit is small, locally supplying power to enhance peak luminance (power limit control) is proposed. By this method, it is possible to partially produce higher luminance compared to normal local dimming and to enhance contrast, but a problem as below is caused in a case where a main screen and one or more secondary screens are displayed on one display panel.

FIG. 8 is a diagram when two screens of a main screen and a secondary screen are displayed, and 101 denotes the main screen and 102 denotes the secondary screen in the diagram. In the case of performing the above-described power limit control in a state of displaying the main screen 101 and the secondary screen 102, power P in which power P1 which is able to be supplied to a backlight corresponding to a display area of the main screen 101 and power P2 which is able to be supplied to a backlight corresponding to a display area of the secondary screen 102 are summed is controlled so as to be constant. Then, since the power P2 which is able to be supplied to the secondary screen 102 is changed according to an input video signal by power limit control, the power P1 which is able to be supplied to the main screen 101 is also changed accordingly.

For example, in a case where a video of the secondary screen 102 is a dark video, light emission luminance of the backlight corresponding to the display area of the secondary screen 102 is controlled to be low, and therefore the power P2 which is able to be supplied to the secondary screen 102 decreases. The power P1 which is able to be supplied to the main screen 101 thus increases, and light emission luminance of the backlight corresponding to the display area of the main screen 101 becomes higher than necessary. Furthermore, on the contrary, in a case where the video of the secondary screen 102 is a bright video, the light emission luminance of the backlight corresponding to the display area of the secondary screen 102 is controlled to be high, and therefore the power P2 which is able to be supplied to the secondary screen 102 increases. The power P1 which is able to be supplied to the main screen 101 thus decreases, and the light emission luminance of the backlight corresponding to the display area of the main screen 101 becomes lower than necessary.

That is, in the case of displaying the main screen and one or more secondary screens while power limit control is being performed, screen luminance of the main screen is affected by not only a video signal of the main screen but also video signals of the secondary screens, so that the screen luminance of the main screen changes more than necessary, resulting that display quality of the main screen is deteriorated. Note that, an invention described in Patent Document 1 above is not for performing local dimming and further power limit control, and thus is not able to solve such an issue.

The present invention has been made in view of circumstances as described above, and aims to, in a video display device which divides a backlight into a plurality of areas and controls luminance of the backlight according to a video signal corresponding to each area, when a main screen and one or more secondary screens are displayed, enable to suitably control screen luminance of the main screen without being affected by a video signal of the secondary screen.

### Means for Solving the Problem

To solve the above problems, a first technical means of the present invention is a video display device, comprising a display panel that displays a video signal, a backlight that uses an LED as a light source for illuminating the display panel, and a control portion that controls light emission luminance of the LED, the control portion dividing the backlight into a plurality of areas and controlling light emission luminance of an LED corresponding to each of the divided areas according to a video signal corresponding to each of the divided areas, wherein when a main screen and one or more secondary screens are displayed on the display panel, the control portion performs first luminance control for controlling light emission luminance of an LED corresponding to a display area of the main screen in a range where a total value of drive current of the LED is equal to or less than a predetermined allowable current value based on alighting rate of a backlight of the main screen or a feature amount of a video signal of the main screen, and independently of the first luminance control, performs second luminance control for controlling light emission luminance of an LED corresponding to a display area of the secondary screen at least other than a boundary area with the main screen to be constant.

A second technical means is the video display device of the first technical means, wherein when a boundary line between the main screen and the secondary screen is positioned between LEDs of the backlight, the second luminance control is for controlling light emission luminance of an LED corresponding to the boundary area and the light emission luminance of the LED corresponding to the display area of the secondary screen other than the boundary area to have a same fixed value.

A third technical means is the video display device of the first technical means, wherein when a boundary line between the main screen and the secondary screen is positioned between LEDs of the backlight, the second luminance control is for controlling light emission luminance of an LED corresponding to the boundary area and the light emission luminance of the LED corresponding to the display area of the secondary screen other than the boundary area to have different fixed values.

A fourth technical means is the video display device of the first technical means, wherein when a boundary line between the main screen and the secondary screen is positioned on the LED of the backlight, the second luminance control is for controlling light emission luminance of an LED corresponding to the boundary area and the light emission luminance of the LED corresponding to the display area of the secondary screen other than the boundary area to have different fixed values.

A fifth technical means is the video display device of the third or the fourth technical means, wherein the control portion determines the fixed value of the light emission luminance of the LED corresponding to the boundary area based on the feature amount of the video signal displayed on the main screen.

A sixth technical means is the video display device of the fifth technical means, wherein when the feature amount of the video signal displayed on the main screen is equal to or more than a first predetermined value, the light emission luminance of the LED corresponding to the boundary area is made larger than the light emission luminance of the LED corresponding to the display area of the secondary screen other than the boundary area, and when the feature amount of the video signal displayed on the main screen is equal to or less than a second predetermined value, the light emission luminance of the LED corresponding to the boundary area is made smaller than the light emission luminance of the LED corresponding to the display area of the secondary screen other than the boundary area.

A seventh technical means is the video display device of the first technical means, wherein when a boundary line between the main screen and the secondary screen is positioned on the LED of the backlight, the control portion controls light emission luminance of an LED corresponding to the boundary area by the first luminance control, corrects a video signal of the secondary screen included in the boundary area, and further controls the light emission luminance of the LED corresponding to the display area of the secondary screen other than the boundary area to be constant by the second luminance control.

### Effect of the Invention

According to the present invention, in a video display device which divides a backlight into a plurality of areas and controls luminance of the backlight according to a video signal corresponding to each area, when a main screen and one or more secondary screens are displayed, light emission luminance of an LED corresponding to a display area of the secondary screen at least other than a boundary area with the main screen is able to be controlled to be constant, so that it is possible to suitably control screen luminance of the main screen without being affected by a video signal of the secondary screen.

### BRIEF DESCRIPTION OF DRAWINGS

FIG. 1 is a block diagram showing an exemplary configuration of a main part of a video display device according to one embodiment of the present invention.

FIG. 2 is a diagram showing one example of a video processed by the video display device.

FIG. 3 is a diagram explaining a method for setting maximum light emission luminance of an LED of an LED backlight.

FIG. 4 is a diagram explaining one example of light emission luminance control when two screens of a main screen and a secondary screen are displayed.

FIG. 5 is a diagram explaining another example of light emission luminance control when two screens of a main screen and a secondary screen are displayed.

FIG. 6 is a diagram showing exemplary screens when one main screen and a plurality of secondary screens are displayed.

FIG. 7 is a diagram showing one example of a luminance control function which is applied to a main screen and a luminance control function which is applied to a secondary screen.

FIG. 8 is a diagram when two screens of a main screen and a secondary screen are displayed.

### PREFERRED EMBODIMENT OF THE INVENTION

Description will hereinafter be given for preferred embodiments according to a video display device of the present invention with reference to accompanied drawings.

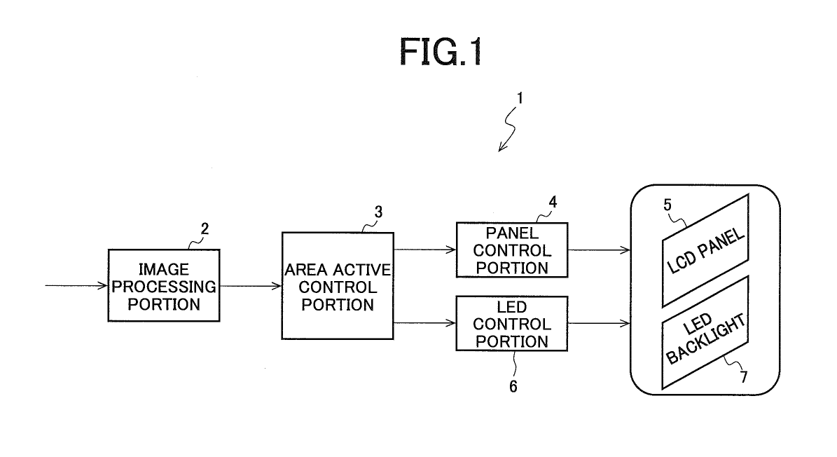

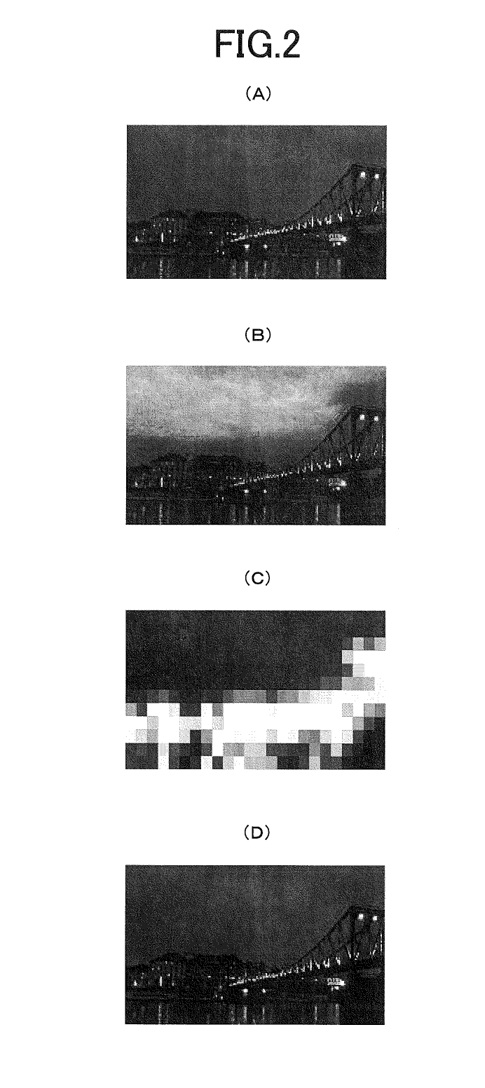

FIG. 1 is a block diagram showing an exemplary configuration of a main part of a video display device according to one embodiment of the present invention, and 1 denotes the video display device in the diagram. Moreover, FIG. 2 is a diagram showing one example of a video processed by the video display device 1. The video display device 1 is able to be exemplified as, for example, a liquid crystal display device, and provided with an image processing portion 2, an area active control portion 3, a panel control portion 4, an LCD (Liquid Crystal Display) panel 5, an LED (Light Emitting Diode) control portion 6, and an LED backlight 7.

The image processing portion 2 receives video and sound signals separated from a broadcast signal and video and sound signals from external equipment, and performs video signal processing such as decoding of video and sound signals which are encoded. An example of a video signal input to the image processing portion 2 is shown in FIG. 2(A). The image processing portion 2 executes image processing, for example, such as IP conversion, noise reduction, scaling processing, y adjustment, and white balance adjustment for the input video signal as appropriate and outputs the video signal after the image processing to the area active control portion 3.

In addition, the image processing portion 2 receives an instruction of setting a multi-screen display mode or an instruction of canceling the multi-screen display mode performed by a viewer using a remote controller (not shown) or the like. This multi-screen display mode is a mode for displaying a main screen and one or more secondary screens. For example, a usage mode that a television video is displayed on the main screen and a Web video of the Internet is displayed on the secondary screen, or television videos of different channels are displayed on the main screen and the secondary screen, etc. are considered. Furthermore, when receiving the instruction of setting the multi-screen display mode, the image processing portion 2 synthesizes a video signal of the main screen with a video signal of the secondary screen and outputs the synthesized video signal to the area active control portion 3.

The area active control portion 3 executes local dimming processing. Specifically, in accordance with the video signal input by the image processing portion 2, the area active control portion 3 divides an image displayed by the video signal into predetermined areas and extracts a feature amount (for example, maximum gray level value) of the video signal for each divisional area.

The area active control portion 3 then performs control of light emission luminance according to the extracted maximum gray level value by increasing light emission luminance of an LED of the LED backlight 7 for an area where the maximum gray level value is large and decreasing the light emission luminance of the LED for an area where the maximum gray level value is small, or the like.

Note that, though it is set here that the light emission luminance of the LED is controlled using the maximum gray level value of each divisional area, the light emission luminance of the LED may be controlled using other feature amount such as an average gray level value of each divisional area.

Further, the area active control portion 3 performs power limit control for improving contrast by further enhancing luminance of the LED backlight 7 while keeping a total value of drive current for lighting each LED of the LED backlight 7 at a predetermined allowable current value or less.

Specifically, the area active control portion 3 calculates a lighting rate of the LED backlight 7 corresponding to each divisional area based on the maximum gray level value of the video signal extracted for each divisional area. This lighting rate is a proportion of the maximum gray level value of the video signal in each divisional area to a gray level value which the video signal possibly takes.

For example, when the gray level value which the video signal possibly takes is 256th gray level (0 to 255), there are eight divisional areas, and the maximum gray level values of the video signal in the eight divisional areas are 64, 224, 160, 32, 128, 192, 192 and 96, the lighting rates of the LED backlight 7 corresponding to the respective divisional areas are 25.0%, 87.8%, 62.7%, 12.5%, 50.2%, 75.3%, 75.3% and 37.6%, respectively.

Moreover, the area active control portion 3 calculates an average lighting rate. In the example described above, the average lighting rate is obtained as 53.3% from the lighting rates of the respective divisional areas above. Then, the area active control portion 3 uses the average lighting rate to set maximum light emission luminance of the LED of the LED backlight 7.

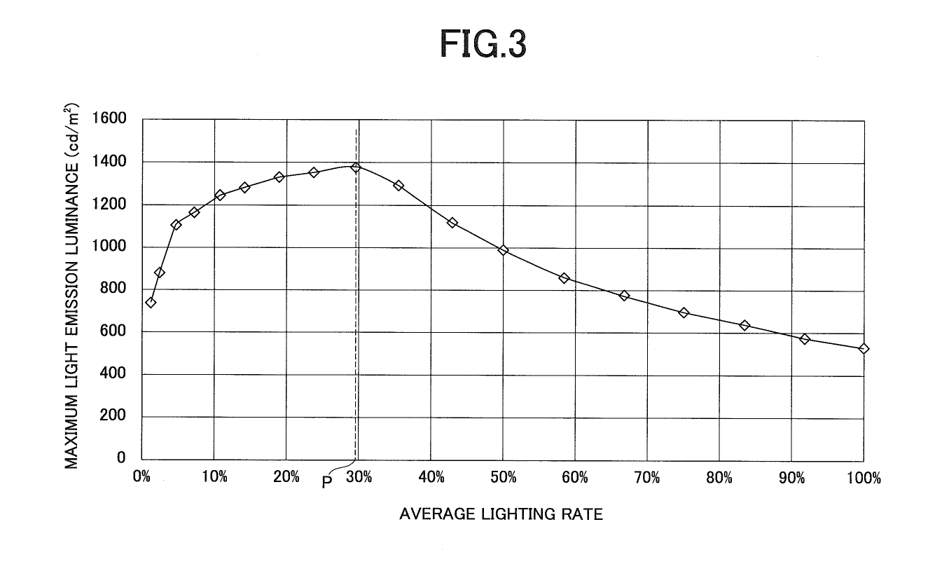

FIG. 3 is a diagram explaining a method for setting maximum light emission luminance of an LED of the LED backlight 7. A horizontal axis of FIG. 3 is an average lighting rate (%) of the LED backlight 7. The average lighting rate is 0% in a state where all LEDs of each area of the LED backlight 7 corresponding to each divisional area are unlit, and is 100% in a state where all LEDs of each area of the LED backlight 7 corresponding to each divisional area are lit. A vertical axis of FIG. 3 indicates maximum light emission luminance (cd/m²) of an LED of the LED backlight 7 in each average lighting rate.

It is set that a total value of drive current for lighting each LED of the LED backlight 7 is constant in power limit control. In a range where the average lighting rate is larger than P, as the average lighting rate becomes larger, current that is able to be supplied to a single divisional area becomes smaller, so that the maximum light emission luminance becomes smaller.

Furthermore, in an area where the average lighting rate is large, a video appears dazzling, but when the maximum light emission luminance becomes smaller, this dazzling is suppressed. Moreover, when the average lighting rate is near P, the maximum light emission luminance becomes maximum. When the maximum light emission luminance becomes larger, reproducibility of a color of a light source such as the sun or light is improved.

In a range where the average lighting rate is smaller than P, it is also possible to further increase the maximum light emission luminance, but because a video in this range is a dark video, by decreasing the maximum light emission luminance, true black representation is realized and black floating is suppressed to keep display quality.

The area active control portion 3 determines final luminance of each divisional area using a relation shown in FIG. 3, and outputs data of the determined luminance to the LED control portion 6. Specifically, the area active control portion 3 multiplies the luminance determined for each divisional area according to the maximum gray level value by local dimming processing by a luminance increasing rate to thereby determine the final luminance of each divisional area. Here, the luminance increasing rate means a ratio of a/b when the maximum light emission luminance in a certain average lighting rate is a and the maximum light emission luminance in the average lighting rate of 100% is b.

For example, in a case where the maximum light emission luminance when the average lighting rate is 64.0% is 800 cd/m² and the maximum light emission luminance when the average lighting rate is 100% is 533 cd/m², the luminance increasing rate a/b is 1.5.

In this case, the area active control portion 3 multiplies the luminance determined for each divisional area according to the maximum gray level value by local dimming processing by 1.5 to thereby determine the final luminance of each divisional area. Note that, it is set that the relation between the maximum luminance and the average lighting rate shown in FIG. 3 is stored in advance in a storage portion (not shown) provided in the video display device 1.

Moreover, the area active control portion 3 outputs control data for controlling the LCD panel 5 to the panel control portion 4 for video display.

The panel control portion 4 uses the control data output by the area active control portion 3 to control display of a video in the LCD panel 5. In FIG. 2(B), an example of a video signal output to the LCD panel 5 is shown. The LCD panel 5 is a display panel such as a liquid crystal panel and displays a video by being illuminated by the LED of the LED backlight 7.

The LED control portion 6 uses the data of luminance output by the area active control portion 3 to control the light emission luminance of the LED of the LED backlight 7. An example of controlling LED light emission luminance of the LED backlight 7 is shown in FIG. 2 (C).

The LED backlight 7 is a backlight using the LED as a light source for illuminating the LCD panel 5. One example of a video obtained as a result of illuminating the LCD panel 5 with the LED backlight 7 is shown in FIG. 2 (D). The luminance of the LED of the LED backlight 7 is controlled by PWM control, but may be controlled so as to have a desired value by current control or a combination of them.

Note that, though description has been given above for a case where the luminance is controlled using a lighting rate of the LED backlight 7, the same control is able to be performed also by using an APL (Average Picture Level) of a video signal.

Since the APL is an average value of the luminance of the entire video signal, a relation between the APL and the maximum luminance of the LED is considered to show the same tendency with one shown in FIG. 3. That is, when the APL of the video signal is low, the lighting rate of the LED backlight 7 is also low, and when the APL of the video signal is high, the lighting rate of the LED backlight 7 is also high. Accordingly, the same control is able to be performed also when the horizontal axis of FIG. 3 is the APL.

A main object of the present invention is, in a video display device which divides a backlight into a plurality of areas and controls luminance of the backlight according to a video signal corresponding to each area, when a main screen and one or more secondary screens are displayed, to suitably control screen luminance of the main screen without being affected by a video signal of the secondary screen. For such a configuration, the video display device 1 is provided with the LCD panel 5 which is one example of the display panel for displaying the video signal, the LED backlight 7 which corresponds to the backlight using the LED as a light source for illuminating the LCD panel 5, and the control portion which controls light emission luminance of the LED of the LED backlight 7. A function as this control portion is realized by the area active control portion 3 and the LED control portion 6.

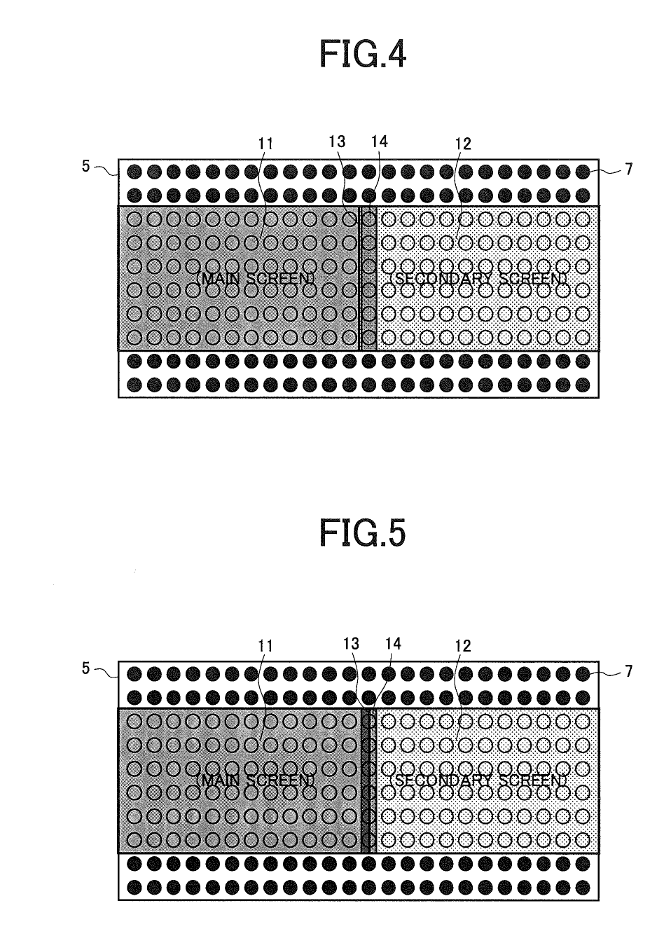

Furthermore, when a main screen and one or more secondary screens are displayed on the LCD panel 5, the area active control portion 3 performs first luminance control for controlling light emission luminance of the LED corresponding to a display area of the main screen in a range where a total value of drive current of the LED is equal to or less than a predetermined allowable current value based on a lighting rate of the LED backlight 7 of the main screen or a feature amount of a video signal of the main screen, and independently of the first luminance control, performs second luminance control for controlling light emission luminance of the LED corresponding to a display area of the secondary screen at least other than a boundary area with the main screen to be constant. Here, as shown in FIG. 4, when a boundary line between the main screen and the secondary screen is between the LEDs, the boundary area is included in the display area of the secondary screen. Moreover, as shown in FIG. 5, when the boundary line between the main screen and the secondary screen is on the LED, the boundary area is included in both of the display area of the main screen and the display area of the secondary screen.

In the above, power limit control described above is performed as the first luminance control for the display area of the main screen, and power limit control is not performed but light emission luminance of the LED of the LED backlight 7 is controlled to be constant as the second luminance control for the display area of the secondary screen. Specifically, a current value supplied to the LED backlight 7 or a duty of the LED backlight 7 is set as a fixed value regardless of an input video signal, so that the LED is caused to emit light with constant luminance. Note that, the current value or the duty used for the second luminance control may be stored in a not-shown memory in advance.

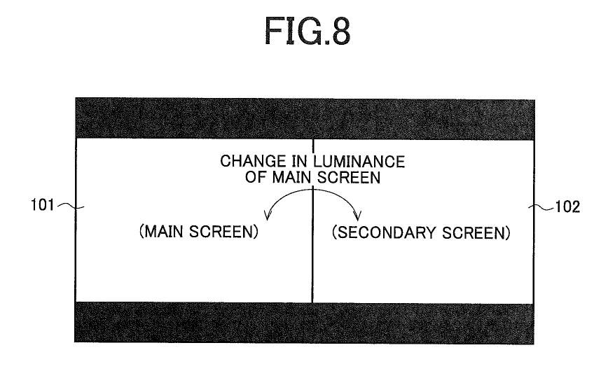

As explained in FIG. 8 above, when power limit control is performed, it is controlled so that power P in which power P1 which is able to be supplied to the backlight corresponding to the display area of the main screen and power P2 which is able to be supplied to the backlight corresponding to the display area of the secondary screen are summed becomes constant. According to the present invention, since the power P2 which is able to be supplied to the secondary screen is fixed regardless of a video signal, the power P1 which is able to be supplied to the main screen always becomes constant. Note that, this power P1 is power when a total value of drive current of the LED corresponding to the display area of the main screen is a predetermined allowable current value. In this manner, since luminance control is performed independently for the main screen and the secondary screen, it is possible to perform suitable power limit control based on the power P1 without being affected by the video signal of the secondary screen in the main screen.

Further, since the power P2 which is supplied to the secondary screen is fixed, the light emission luminance of the LED corresponding to the display area of the secondary screen always becomes constant. Therefore, though there are some demerits in terms of image quality compared to the main screen, it is considered that a great problem is not caused even though sacrificing image quality for the secondary screen to a certain degree because a viewer generally views the main screen mainly.

FIG. 4 is a diagram explaining one example of light emission luminance control when two screens of a main screen and a secondary screen are displayed. In the diagram, 11, 12, 13, and 14 denote a main screen, a secondary screen, a boundary line between the main screen 11 and the secondary screen 12, and a boundary area between the main screen 11 and the secondary screen 12, respectively. In this example, the main screen 11 and the secondary screen 12 are displayed on the LCD panel 5, and a plurality of LEDs constituting the LED backlight 7 are arranged in a matrix state. Furthermore, the boundary line 13 between the main screen 11 and the secondary screen 12 is positioned between the LEDs of the LED backlight 7. In this case, the area active control portion 3 controls the LED control portion 6 to thereby control light emission luminance of the LED corresponding to the boundary area 14 and light emission luminance of the LED corresponding to a display area of the secondary screen 12 other than the boundary area 14 to have a same fixed value. Specifically, current values supplied to the LED or duties of the LED are set to a same value for the boundary area 14 and the other display area among the display area of the secondary screen 12. Note that, power limit control is executed for a display area of the main screen 11 independently from the secondary screen 12.

Moreover, the area active control portion 3 may control the LED control portion 6 to thereby control the light emission luminance of the LED corresponding to the boundary area 14 between main screen 11 and the secondary screen 12 and the light emission luminance of the LED corresponding to the display area of the secondary screen 12 other than the boundary area 14 to have different fixed values and control each light emission luminance of the LED backlight 7 to be constant. Specifically, the current values supplied to the LED or the duties of the LED are set to different values for the boundary area 14 and the other display area among the display area of the secondary screen 12. Note that, in this case as well, power limit control is executed for the display area of the main screen 11 independently from the secondary screen 12.

In the above, when controlling the boundary area 14 and the other display area to have different fixed values, the area active control portion 3 is able to determine the fixed value of the light emission luminance of the LED corresponding to the boundary area 14 based on a feature amount of a video signal displayed on the main screen 11. Note that, as the feature amount of the video signal, for example, an APL (Average Picture Level) of the video signal or the like is able to be used.

For example, when the feature amount of the video signal displayed on the main screen 11 is equal to or more than a first predetermined value, that is, when the video signal of the main screen 11 is a bright video, the light emission luminance of the main screen 11 is controlled to be high. Note that, there is a relation of the light emission luminance of the main screen 11>the light emission luminance of the secondary screen 12. However, when the light emission luminance of the boundary area 14 and the other display area is controlled to be constant in the secondary screen 12, a possibility is thereby caused that a lack of luminance occurs in a vicinity of the boundary line 13 in the main screen 11. Thus, in this example, the light emission luminance of the LED corresponding to the boundary area 14 is made larger than the light emission luminance of the LED corresponding to the display area of the secondary screen 12 other than the boundary area 14. That is, the fixed value of the light emission luminance of the LED corresponding to the boundary area 14 is set to be higher than the fixed value of the light emission luminance of the LED corresponding to the other display area of the secondary screen 12, so that it is possible to prevent the occurrence of the above-described lack of luminance.

Moreover, when the feature amount of the video signal displayed on the main screen 11 is equal to or less than a second predetermined value, that is, when the video signal of the main screen 11 is a dark video, the light emission luminance of the main screen 11 is controlled to be low. Note that, there is a relation of the light emission luminance of the main screen 11<the light emission luminance of the secondary screen 12. However, when the light emission luminance of the boundary area 14 and the other display area is controlled to be constant in the secondary screen 12, a possibility is thereby caused that leakage of light occurs in a vicinity of the boundary line 13 in the main screen 11. Thus, in this example, the light emission luminance of the LED corresponding to the boundary area 14 is made smaller than the light emission luminance of the LED corresponding to the display area of the secondary screen 12 other than the boundary area 14. That is, the fixed value of the light emission luminance of the LED corresponding to the boundary area 14 is set to be lower than the fixed value of the light emission luminance of the LED corresponding to the other display area of the secondary screen 12, so that it is possible to prevent the occurrence of the above-described leakage of light.

FIG. 5 is a diagram explaining another example of light emission luminance control when two screens of a main screen and a secondary screen are displayed. In the case of this example, differently from the example of FIG. 4, the boundary line 13 between the main screen 11 and the secondary screen 12 is positioned on the LED of the LED backlight 7. Furthermore, the area active control portion 3 controls the LED control portion 6 to thereby control the light emission luminance of the LED corresponding to the boundary area 14 between the main screen 11 and the secondary screen 12 and the light emission luminance of the LED corresponding to the display area of the secondary screen 12 other than the boundary area 14 to have different fixed values and control each light emission luminance of the LED backlight 7 to be constant. Specifically, the current values supplied to the LED or the duties of the LED are set to different values for the boundary area 14 with the main screen 11 and the other display area. Note that, since a method for controlling the light emission luminance in this example is the same as the example of FIG. 4, repetitive description here is omitted.

Further, description will be given for a still another mode based on FIG. 5. When the boundary line 13 between the main screen 11 and the secondary screen 12 is positioned on the LED of the LED backlight 7, the light emission luminance of the LED corresponding to the boundary area 14 between the main screen 11 and the secondary screen 12 may be controlled by power limit control based on the video signal of the main screen 11 and the video signal of the secondary screen 12 included in the boundary area 14 may be corrected, and further the light emission luminance of the LED corresponding to the display area of the secondary screen 12 other than the boundary area 14 may be controlled to be constant.

For the correction of the video signal of the secondary screen 12 included in the boundary area 14 in the above, for example, it is considered to adjust a gain of the video signal. Here, the light emission luminance of the LED corresponding to the boundary area 14 is controlled according to the video signal of the main screen 11 by power limit control. However, since the video signal of the secondary screen 12 is also included in this boundary area 14, change in the luminance by the LED affects the secondary screen 12 as well. Thus, it is desired to correct an amount of the change in the luminance by the LED by adjusting a gain of the video signal of the secondary screen 12. This makes it possible to have substantially same screen luminance of the secondary screen 12 between the boundary area 14 and the other display area.

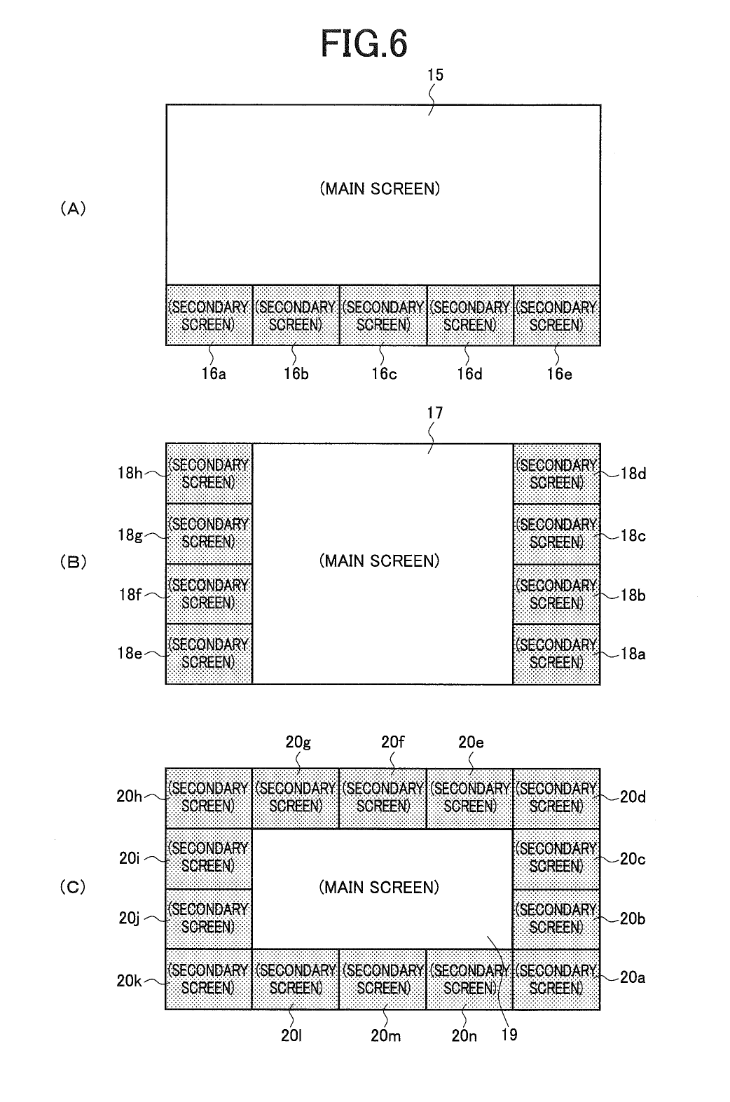

FIG. 6 is a diagram showing exemplary screens when one main screen and a plurality of secondary screens are displayed. A numeral signal 15 denotes a main screen and 16a to 16e denote secondary screens in FIG. 6(A), 17 denotes a main screen and 18a to 18h denote secondary screens in FIGS. 6 (B), and 19 denotes a main screen and 20a to 20n denote secondary screens in FIG. 6(C). In this manner, the present invention is not limited to two-screen display of one main screen and one secondary screen, and is able to be applied in the same manner also to a case where one main screen and a plurality of secondary screens are displayed. Moreover, a plurality of patterns of arrangement (layout) of the main screen and the plurality of secondary screens may be held in a memory in advance so that a user is able to select a desired arrangement pattern.

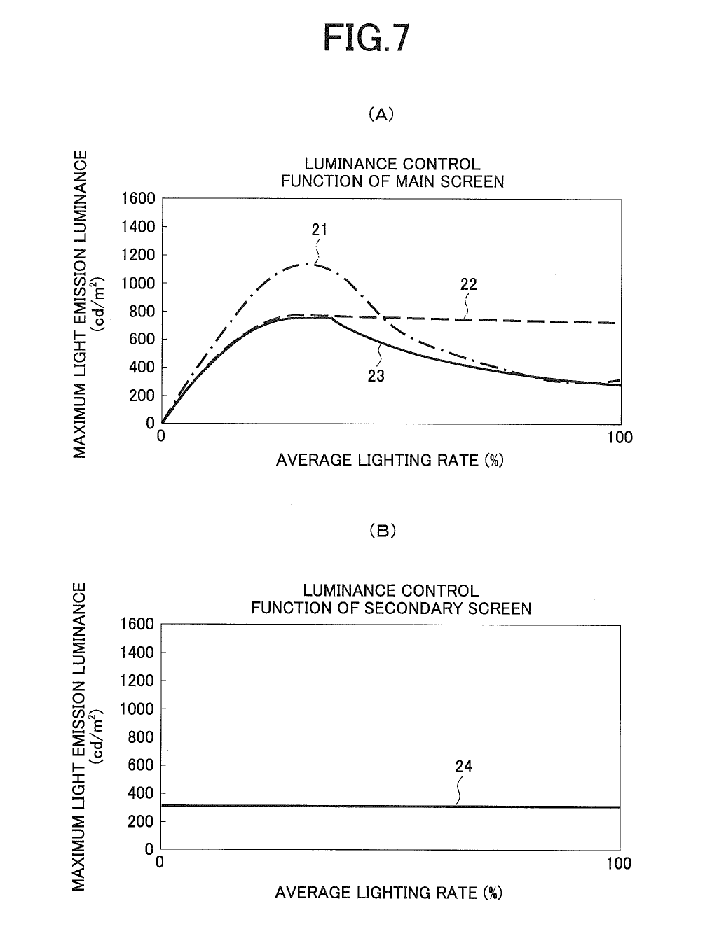

FIG. 7 is a diagram showing one example of a luminance control function which is applied to a main screen and a luminance control function which is applied to a secondary screen, and a vertical axis indicates maximum light emission luminance (cd/m²) and a horizontal axis indicates an average lighting rate (%) in the diagrams. The luminance control function which is applied to the main screen is able to be adjusted depending on intended use as shown in FIG. 7(A). In the example of FIG. 7(A), three kinds of luminance control functions 21 to 23 are exemplified, but not limited thereto. Further, the luminance control function which is applied to the secondary screen is a fixed value 24 (constant light emission luminance) as shown in FIG. 7(B), but a plurality of fixed values may be held, for example, according to an area to be displayed in the secondary screen.

### EXPLANATIONS OF LETTERS OR NUMERALS

1 . . . video display device, 2 . . . image processing portion, 3 . . . area active control portion, 4 . . . panel control portion, 5 . . . LCD panel, 6 . . . LED control portion, 7 . . . LED backlight, 11, 15, 17 and 19 . . . main screen, 12, 16a to 16e, 18a to 18h and 20a to 20n . . . secondary screen, 13 . . . boundary line, 14 . . . boundary area, 21 to 23 . . . luminance control function, and 24 . . . fixed value.

1. A video display device, comprising a display panel that displays a video signal, a backlight that uses an LED as a light source for illuminating the display panel, and a control portion that controls light emission luminance of the LED, the control portion dividing the backlight into a plurality of areas and controlling light emission luminance of an LED corresponding to each of the divided areas according to a video signal corresponding to each of the divided areas, wherein
when a main screen and one or more secondary screens are displayed on the display panel, the control portion performs first luminance control for defining light emission luminance of an LED corresponding to a display area of the main screen according to a feature amount of a video indicated by the video signal displayed on a display area corresponding to each of the divided areas in the main screen and setting a part of the light emission luminance of the LED to be equal to or more than light emission luminance in the case of a video of white 100%, and independently of the first luminance control, performs second luminance control for controlling light emission luminance of an LED corresponding to a display area of the secondary screen at least other than a boundary area with the main screen to be constant.

2. The video display device according to claim 1, wherein
the boundary area is
included in the display area of the secondary screen when a boundary line between the main screen and the secondary screen is positioned between LEDs of the backlight, and
included in both of the display area of the main screen and the display area of the secondary screen when the boundary line between the main screen and the secondary screen is positioned on the LED of the backlight.

3. The video display device according to claim 1, wherein
when a boundary line between the main screen and the secondary screen is positioned between LEDs of the backlight, the second luminance control is for controlling light emission luminance of an LED corresponding to the boundary area and the light emission luminance of the LED corresponding to the display area of the secondary screen other than the boundary area to have a same fixed value.

4. The video display device according to claim 1, wherein
when a boundary line between the main screen and the secondary screen is positioned on between LEDs of the backlight, the second luminance control is for controlling light emission luminance of an LED corresponding to the boundary area and the light emission luminance of the LED corresponding to the display area of the secondary screen other than the boundary area to have different fixed values.

5. The video display device according to claim 1, wherein
when a boundary line between the main screen and the secondary screen is positioned on the LED of the backlight, the second luminance control is for controlling light emission luminance of an LED corresponding to the boundary area and the light emission luminance of the LED corresponding to the display area of the secondary screen other than the boundary area to have different fixed values.

6. The video display device according to claim 4, wherein
the control portion determines the fixed value of the light emission luminance of the LED corresponding to the boundary area based on the feature amount of the video signal displayed on the main screen.

7. The video display device according to claim 6, wherein
when feature amount of the video signal displayed on the main screen is equal to or more than a first predetermined value, the light emission luminance of the LED corresponding to the boundary area is made larger than the light emission luminance of the LED corresponding to the display area of the secondary screen other than the boundary area, and when the feature amount of the video signal displayed on the main screen is equal to or less than a second predetermined value, the light emission luminance of the LED corresponding to the boundary area is made smaller than the light emission luminance of the LED corresponding to the display area of the secondary screen other than the boundary area.

8. The video display device according to claim 5, wherein
the control portion determines the fixed value of the light emission luminance of the LED corresponding to the boundary area based on the feature amount of the video signal displayed on the main screen.

9. The video display device according to claim 8, wherein
when the feature amount of the video signal displayed on the main screen is equal to or more than a first predetermined value, the light emission luminance of the LED corresponding to the boundary area is made larger than the light emission luminance of the LED corresponding to the display area of the secondary screen other than the boundary area, and when the feature amount of the video signal displayed on the main screen is equal to or less than a second predetermined value, the light emission luminance of the LED corresponding to the boundary area is made smaller than the light emission luminance of the LED corresponding to the display area of the secondary screen other than the boundary area.

10. The video display device according to claim 1, wherein
when a boundary line between the main screen and the secondary screen is positioned on the LED of the backlight, the control portion controls light emission luminance of an LED corresponding to the boundary area by the first luminance control, corrects a video signal of the secondary screen included in the boundary area, and further controls the light emission luminance of the LED corresponding to the display area of the secondary screen other than the boundary area to be constant by the second luminance control.
